(19) United States
(12) Patent Application Publication
(10) Pub. No.: US 2008/0249789 A1
(43) Pub. Date: Oct. 9, 2008

(54) SYSTEM AND METHOD FOR PROVIDING ROYALTY OFFERS TO MINERAL INTEREST OWNERS

(75) Inventor: Willam R. Sinclair, Dallas, TX (US)

Correspondence Address: HOWISON & ARNOTT, L.L.P, P.O. BOX 741715, DALLAS, TX, 75374-1715, US

(73) Assignee: AGELIO NETWORKS, INC., Dallas, TX (US)

(21) Appl. No.: 11/697,013

(22) Filed: Apr. 5, 2007

(51) Int. Cl. G06Q 90/00

(52) U.S. Cl. 705/1; 715/700

(57) ABSTRACT

A system and method provides potential offers for royalty interest to royalty interest owners. A determination is made from public records of a potential money offer for a particular royalty interest. This information is stored within a database. Royalty interest owners of a particular royalty interest are provided with an access code enabling access to the money offer for a particular royalty interest. A server enables the display of the potential money offer to the royalty interest owner using a graphical user interface presented to the royalty interest owner via an Internet browser. The display of the graphical user interface is enabled responsive to the entry of access code by the royalty interest owner.

### TECHNICAL FIELD

The present invention relates to royalty offers, and more particularly, to a system and method for managing and providing royalty offers to a plurality of mineral interest royalty owners via the Internet.

### CROSS-REFERENCE TO RELATED APPLICATIONS

None.

### BACKGROUND

Mineral ownership royalty interests are often divided amongst a number of people with respect to a single piece of property. When considering the properties located throughout a particular county or regional area, the number of owners quickly becomes difficult to manage. Some companies engage in with the buying and selling of mineral royalty ownership interest and when attempting to acquire various mineral royalty interest, the largest amount of time involves contacting the potential sellers and providing them a proposed offer for the interest. This ownership information is normally a matter of public record for producing oil and gas property interests. This is public information that is available from county tax rolls or other public information sources. Using this public information, companies interested in buying these types of interest may perform further evaluation of producing properties. However, there is a need for a manner of more easily contacting and providing information to potential sellers of royalty interests.

### SUMMARY

The present invention, as disclosed and claimed herein, in one aspect thereof, comprises a system and method for providing potential offers for royalty interests to royalty interest owners. Initially, a determination of a potential money offer is made for at least one royalty interest. This information is stored in a database. Royalty interest owners of the royalty interest are provided with an access code enabling access to the potential money offer for the particular royalty interest. A server enables display of the potential money offer to the royalty interest owner using a graphical user interface presented to the royalty interest owner over the Internet. The display of the graphical user interface is enabled responsive to the entry of the access code provided to the royalty interest owner.

### BRIEF DESCRIPTION OF THE DRAWINGS

For a more complete understanding of the present invention and the advantages thereof, reference is now made to the following description taken in conjunction with the accompanying Drawings in which:

FIG. 1 is a flow diagram generally illustrating the manner for making royalty offers according to the present disclosure;

FIG. 2 illustrates the manner for making royalty offers to a plurality of royalty owners via the Internet;

FIG. 3 is an example of a letter which may be used to contact a royalty owner about their royalty interest;

FIG. 4 illustrates a log-in page by which a royalty owner may access their potential royalty offer via the Internet; and

FIG. 5 illustrates the detailed information provided about a royalty interest for a particular royalty interest owner; and

FIG. 6 is a flow diagram more fully describing the process for making royalty offers.

### DETAILED DESCRIPTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

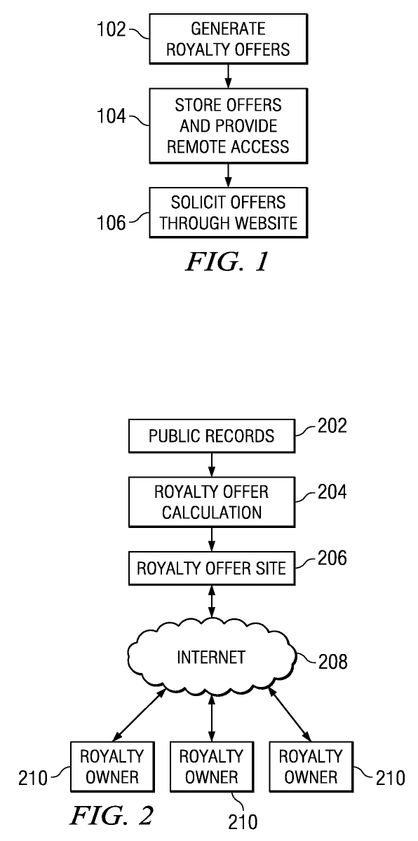

Referring now to FIG. 1, there is illustrated a flow diagram describing the general method for making potential offers to royalty interest owners. Initially, at step 102, the royalty offers are generated. The royalty offers may be generated in any number of fashions utilizing, for example, the public records available through local county offices and publicly available well production data. Once the royalty offers have been generated, the offers are stored within a centralized system database at step 104 such that potential offers may be provided to royalty interest owners via remote access. In the present embodiment, the implementation via remote access utilizes an open network such as the Internet to enable a mineral interest owner to access the royalty interest offer and determine whether they would wish to negotiate with the offer provider.

While the present embodiment envisions utilizing the Internet to provide potential royalty offers, other means for accessing the offers may be utilized such as through the land line telephone network, through the cellular telephone network, or through any other widely accessible network functionalities providing the ability to transmit the information containing the particulars of the royalty interest offer to a potential seller. Once the offers have been stored and access provided at step 104, the offers may be solicited at step 106 via a website on the Internet. This involves transmitting information to the potential royalty interest seller via, for example, a letter or email that encourages them to visit the website having the potential offer related to the royalty interest that they own. As described previously, rather than using the Internet and a website, other types of network communications may be utilized by the potential sellers.

Referring now to FIG. 2, there is illustrated the general operating environment wherein the potential royalty interest offer may be made to a number of royalty interest owners. The process is initiated by accessing public record information 202 that details the royalty interest ownerships and well production data with respect to oil and gas producing properties. In most instances, this information will be located within a local county office and provides the details of who owns particular mineral royalty interests and the percentage of ownership. Using other publicly available information, the production of various wells located on property may be determined to assist in the determination of cash offers for various royalty interests. Once all of the necessary public information has been gathered, this information is utilized to perform a royalty offer calculation 204. The royalty offer calculation 204 determines the revenue that is likely to arise from a particular royalty interest and calculates an offer associated with that particular royalty interest.

Determinations of the totals of the estimated monthly revenue and the potential offer for all of the royalty interest owned by a particular individual are summed and this information is provided to the royalty offer site 206. The royalty offer site 206 provides a website location that is accessed via the Internet 208 by various royalty owners 210. The royalty offer site 206 provides a display of particular royalty interests owned by an individual and describes the estimated revenue coming from a lease interest on a monthly basis. The royalty offer site 206 also provides royalty interest owners with a potential offer for this lease. This offer is used as a basis for negotiations between the royalty owner 210 and the entity desiring to purchase the royalty owner's royalty interest that has generated the offer.

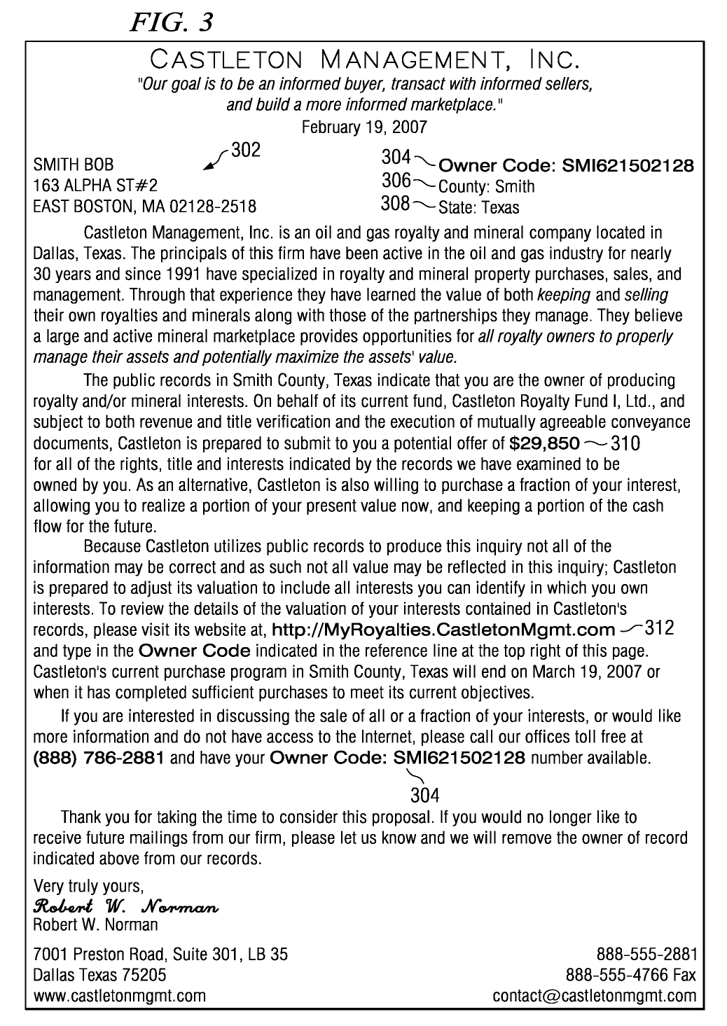

Referring now to FIG. 3, there is provided an illustration of a letter or email which is transmitted to a royalty owner to enable them to open negotiations relating to the selling of their royalty interest. The majority of the letter comprises a standardized template. The address portion 302 provides fields for entry of the name and address of the royalty interest owner. The owner code 304 provides for a code via which the royalty interest owner may access the website relating to their specific royalty interest offer. The county entry 306 and state entry 308 likewise specifically identify the county and state wherein the lease property having the royalty interest is located. The potential offer amount 310 provides for an entry of the amount that the royalty interest owner is being potentially offered with respect to their royalty interest. This amount, of course, is based upon the calculations provided by the royalty offer calculation 204. The only additional different portion of the letter for each royalty interest owner is the second mention of the owner code 304 which is mentioned within the body of the letter directing the royalty interest owner to enter the code upon accessing the indicated website address 312. The website address 312 is provided within the body of the letter to direct the royalty interest owner to the Internet location wherein their potential offer may be viewed. As mentioned hereinabove, rather than an Internet address, the information location could comprise a telephone number or other type of network address locator wherein the royalty interest offer may be reviewed.

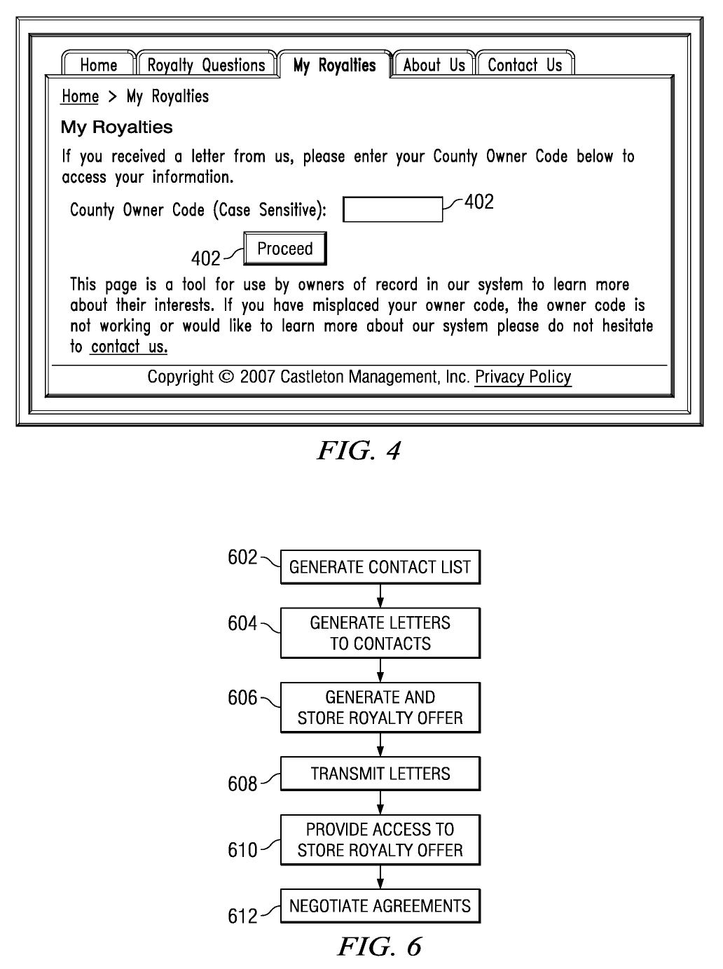

Referring now to FIG. 4, there is provided an illustration of the graphical user interface log-in page a royalty owner is directed to when they enter the Internet address 312 indicated within their contact letter of FIG. 3. The log-in page is accessed through an Internet browser of a royalty owner's computer and is displayed upon entry of the web address provided in their contact letter. The log-in page includes a county owner code field 402 into which the owner code 304 (FIG. 3) is entered that was provided to the royalty interest owner in their contact letter. Once the owner code 304 has been entered into the field 402, the royalty owner accesses their royalty offer information by actuating the proceed button 404 using, for example, a point and click routine utilizing a mouse or other pointing device associated with the computer through which they are accessing the website.

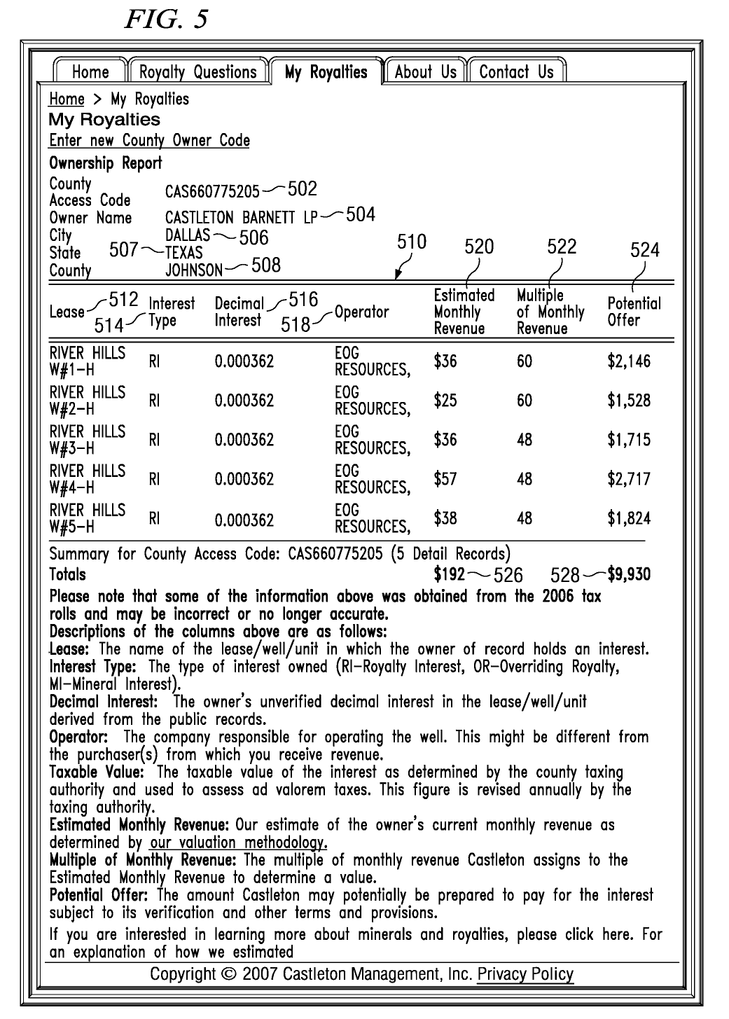

Referring now to FIG. 5, there is illustrated an ownership report related to a particular royalty interest owner. This is the graphical display provided to a royalty interest owner responsive to entry of a valid owner code 304. The ownership report contains various types of information related to the royalty interest owned by a particular individual. An access code field 502 provides the access code which the royalty owner was required to enter in order to obtain their potential royalty interest offer and corresponds to the access code through which the royalty interest owner was able to access the ownership report. The owner name field 504 provides the name of the owner of the royalty interest. The city field 506, state field 507 and county field 508 provide the city, state locations of the owner and the county containing the royalty interest.

A royalty interest table 510 provides various information with respect to leases, interest types, decimal interest ownerships, operator, estimated monthly revenues, multiple of monthly revenues, and potential offers with respect to particular royalty interest. The lease column 512 of the royalty interest table 510 includes the name of the lease/well/unit in which the owner of record has a royalty interest. This information is usually obtained from the county records and the county record designation is used. The interest type column 514 describes the type of interest owned by the owner of record. These may include RI for royalty interest, OR for overriding royalty, or MI for mineral interest. Other types of ownership interest may be designated or applicable according to local and state laws.

The decimal interest column 516 indicates the owner's unverified decimal interest in the lease/well/unit that was obtained from the public records. This information would, of course, have to be verified during the negotiation process with the royalty interest owner. The operator column 518 indicates the company responsible for operating the well. The well operator may be different from the purchasers from which the royalty interest operator receives their revenue. The estimated monthly revenue column 520 provides the estimated monthly revenue that has been determined by the company making the offer to purchase the royalty interest. The evaluation of producing oil and gas properties is complex and only provides a point of reference for negotiations. In most cases, actual future production of wells and properties will not be the same as the forecasted future production. Combined with this production variance, product prices are volatile and when combined with production variances, make projections of future cash flow and ultimately value, an estimate at best.

Depending on the circumstances, the best method to determine value is the present value (PV) or discounted cash flow (DCF) method by a reservoir engineer using reservoir engineering computer software. The reservoir engineer will incorporate as much historic and known information available on the selected property as obtainable from public records, apply assumptions about future pricing and production decline rates, and obtain the results for the present value figure of the future cash flow at a particular discount rate.

Another method used within the oil and gas and industry is the multiple of cash flow (MCF) method. While its goal is similar to that of the PV method, the MCF method is easier, quicker and much less costly to perform. However, because the MCF method relies on less specific information, it has a higher level of risk of an inaccurate outcome. In the MCF method, one takes the most recent cash flows and simply applies a multiple to that figure to arrive at a potential value. The increased level of risk occurs because the historic production levels decline and information, projections and assumptions about future production and declines, and projections and assumptions about future pricing are not incorporated into the financial model.

The asset valuation method or asset test is also used to determine potential values of both producing and non-producing properties. The asset valuation method provides its means to “test” the values derived from either DCF or MCF models. In the asset valuation method, assumptions are made about the amount of oil and/or gas reserves “in the ground” (yet to be recovered) and these are divided into a total value figure. The results provide a unit value for the product. As an example, if a property is valued at $1,000,000.00 and it is assumed there are 100,000 barrels of oil in the ground to be recovered over the life of the property, the resulting unit value is $10.00 per barrel of oil. This figure is normally less than the price per barrel currently received at the well head because it reflects discounting of future revenues and the cost of recovering and producing the oil and gas.

To determine an initial value, the present valuation system uses the MCF method while also including recent production volumes and product pricing to arrive at an estimate of current cash flows. However, other valuation methods may also be used. The method applies a multiple of months to arrive at an estimated value figure, which is compared to actual production figures. While the production and product price information vary each day and month, the multiple of cash flows that the market place has historically applied have historically varied little within a range. The variance between the multiples typically depend on the geographic location or geographic area and historic levels of activity or production profile and, in some cases, the perception of future events.

Based upon experience on producing properties in the oil and gas industry, multiples of cash flows have typically ranged from 36 months to 72 months. While some transactions have been for more or less than these figures, historically sellers have been found to have not been receptive to selling below the lower end of this range and buyers have been unwilling to purchase above this range. Within this range, the reasons for variation are numerous, but generally the longer history of production in the property or area the higher the potential multiple.

Column 522 indicates the multiple of monthly revenue that has been assigned to the estimated monthly revenue to determine a final value for a particular royalty interest. This multiple is determined in accordance with the range described hereinabove. Finally, the potential offer column 524 indicates the amount that may be potentially offered to pay for the royalty interest subject to its verification and other terms and provisions. The estimated monthly revenues total field 526 illustrates the total estimated monthly revenues arising from all of the royalty interest owned by the royalty owner. The potential offer totals field 528 indicates the initial potential offer made for all of the royalty owner's interest. The potential offers total 530 is only intended to be a starting point for negotiations between a providing company and the royalty interest owner. The potential offer amount is not intended to be a final offer for acceptance by the royalty interest owner, but only a point to open negotiations.

Referring now to FIG. 6, there is illustrated a detailed flow diagram describing the operation of the disclosed system. Initially, a contact list of royalty interest owners is generated at step 602. This information is gleaned from local county records which are publicly available and detail various ownership interest in oil and gas producing properties within the area. Contact letters or emails for the members of the contact list are generated at step 604. These contact letters would appear similar to the letter illustrated in FIG. 3 and would contain a code identifier enabling the royalty interest owner to access information that has been generated with respect to their particular royalty interest. Using the obtained county data on the royalty interest and information relating to the production of the wells included within the royalty interest, a royalty offer is generated and stored at step 606. The offer with respect to the royalty interest is based upon the multiple of cash flow method described hereinabove that includes recent production volumes and product pricing in order to arrive at the royalty offer. The letters are transmitted to the various contacts at step 608 to enable the contacts to be provided with the information with respect to their royalty offer. The website is updated to provide access to the stored royalty offers at step 610 enabling the various members of the contact list to access the information included within their royalty offer. Utilizing the provided information between the royalty interest owner and a potential buying party may then negotiate agreements with respect to the royalty interest at step 612.

The above-described system and method provides an efficient method for providing potential purchase offers to a large number of royalty interest owners. The system enables determination of royalty interest owners within a county and provides the royalty interest owners with the option of continuing further negotiations with the purchasing company based upon their interest in a potential offer which they are able to view at their leisure via the Internet. In this manner, only those royalty interest owners having the highest degree of interest based upon a particular offer are likely to become involved in negotiations with the purchasing party, as royalty interest owners that have no interest are not likely to contact the buying party and time is saved with respect to both parties.

It will be appreciated by those skilled in the art having the benefit of this disclosure that this invention provides a method for providing offers to royalty interest owners. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A system for providing potential offers for royalty interests to royalty interest owners, comprising:
a database for storing a plurality of potential offers relating to particular royalty interests; and
a server for providing a graphical user interface displaying information on an offer for a particular royalty interest to a royalty interest owner, the graphical user interface displaying the information for the particular royalty interest at a remote location via an Internet browser responsive to entry at the remote location of a code uniquely associated with the royalty interest owner.

2. The system of claim 1, wherein the information displayed includes a potential offer amount associated with the particular royalty interest.

3. The system of claim 2, wherein the information displayed includes an estimated monthly revenue associated with the particular royalty interest and a multiple of monthly revenue associated with the particular royalty interest.

4. The system of claim 2, wherein the information displayed includes an identifier associated with a lease including the particular royalty interest, an indicator of the type of the particular royalty interest, an indication of a decimal interest of the particular royalty interest.

5. The system of claim 1, wherein the graphical user interface displays information on the offer for a plurality of royalty interests for the royalty interest owner, the graphical user interface displaying the information for the plurality of royalty interests at the remote location via the Internet responsive to entry at the remote location of the code uniquely associated with the royalty interest owner.

6. The system of claim 1, wherein the server further provides a second graphical user interface enabling the royalty interest owner to login and obtain access to the graphical user interface responsive to entry of the code uniquely associated with the royalty interest owner.

7. A method for providing potential offers for royalty interests to royalty interest owners, comprising the steps of:
determining from public records a potential money offer for a particular royalty interest;
providing a royalty interest owner of the particular royalty interest with an access code enabling access to the money offer for the particular royalty interest; and
displaying the potential money offer to the royalty interest owner using a graphical user interface presented to the royalty interest owner via an internet browser, the display of the graphical user interface enabled responsive to entry of the access code by the royalty interest owner.

8. The method of claim 7, further including the step of generating a list of royalty interest owners from the public records.

9. The method of claim 8, wherein the step of providing further includes the step of generating a communication to the list of royalty interest owner, the communication including the access code.

10. The method of claim 7 further including the step of storing the potential money offer in a database, the potential money offer accessible via the graphical user interface.

11. The method of claim 7, wherein the step of displaying the potential money offer further comprises the step of displaying an estimated monthly revenue associated with the particular royalty interest and a multiple of monthly revenue associated with the particular royalty interest.

12. The method of claim 7, wherein the step of displaying the potential money offer further comprises the step of displaying an identifier associated with a lease including the particular royalty interest, an indicator of the type of the particular royalty interest, an indication of a decimal interest of the particular royalty interest.

13. The method of claim 7, wherein the step of displaying the potential money offer further comprises the step of displaying a well operator running a well associated with the particular royalty interest.

14. The method of claim 7, wherein the step of displaying the potential money offer further comprises the step of displaying information on the offer for a plurality of royalty interest for the royalty interest owner, the graphical user interface displaying the information for the plurality of royalty interests at the remote location via the Internet responsive to entry at the remote location of the code uniquely associated with the royalty interest owner.

15. The method of claim 7, wherein the step of displaying the potential money offer further comprises the step of displaying a second graphical user interface enabling the royalty interest owner to login and obtain access to the graphical user interface responsive to entry of the access code uniquely associated with the royalty interest owner.

16. A method for providing potential offers for royalty interests to royalty interest owners, comprising the steps of:
generating a list of royalty interest owners from public records;
determining from the public records a plurality of potential money offers for a plurality of royalty interests;
storing the plurality of potential moneys offers in a database, the plurality of potential money offers in the database accessible via a graphical user interface;
providing each of a plurality of royalty interest owners with an access code, each access code enabling access to at least one of the money offers for the plurality of royalty interests; and
displaying the potential money offers to the royalty interest owners using the graphical user interface presented via an internet browser, the display of the graphical user interface enabled responsive to entry of the access code associated with the royalty interest entered by the royalty interest owner.

17. The method of claim 16, wherein the step of providing further includes the step of generating a communication to the list of royalty interest owner, the communication including the access code.

18. The method of claim 16, wherein the step of displaying the potential money offer further comprises the step of displaying a second graphical user interface enabling the royalty interest owner to login and obtain access to the graphical user interface responsive to entry of the access code uniquely associated with the royalty interest owner.

19. The method of claim 16, wherein the step of displaying the potential money offer further comprises the step of displaying an estimated monthly revenue associated with the particular royalty interest and a multiple of monthly revenue associated with the particular royalty interest.

20. The method of claim 19, wherein the step of displaying the potential money offer further comprises the step of displaying an identifier associated with a lease including the particular royalty interest, an indicator of the type of the particular royalty interest, an indication of a decimal interest of the particular royalty interest.
